(19) United States
(12) Patent Application Publication
(10) Pub. No.: US 2019/0052347 A1
(43) Pub. Date: Feb. 14, 2019

(54) COMMUNICATION SYSTEM, CONTROL DEVICE, RELAY DEVICE, CONTROL METHOD, AND STORAGE MEDIUM IN WHICH PROGRAM IS STORED

(71) Applicant: NEC Corporation, Minato-ku, Tokyo (JP)

(72) Inventor: Takahiro OTAKE, Tokyo (JP)

(73) Assignee: NEC Corporation, Minato-ku, Tokyo (JP)

(21) Appl. No.: 16/078,714

(22) PCT Filed: Feb. 20, 2017
(86) PCT No.: PCT/JP2017/006067

§ 371 Date: Aug. 22, 2018

(30) Foreign Application Priority Data
Feb. 26, 2016 (JP) 2016-035377

(51) Int. Cl. H04B 7/155; H04W 68/00; H04W 76/15

(52) U.S. Cl. CPC H04B 7/15542; H04W 76/15; H04W 68/005

(57) ABSTRACT

When each of terminals used by a user determines an OS needed for the host device, it is impossible to carry out flexible OS settings, which could lead to an increase in steps for the user to reset the respective devices or could give rise to a step for device replacement. A communication system in one aspect of the present invention is characterized by including a plurality of relay devices for relaying communication in a network, and a control device for controlling the plurality of relay devices, the control device determining, for each of the plurality of relay devices, an OS that corresponds to each function of the plurality of relay devices on the basis of information pertaining to the configuration of the network.

### TECHNICAL FIELD

The present invention relates to a communication system, a control device, a relay device, a control method, and a program.

### BACKGROUND ART

In a network including a plurality of devices, each of the plurality of devices may be set with an OS different from one another. PTL 1 and PTL 2 disclose a technique in which, in construction of a network including a plurality of devices that execute processing such as transferring and changing data and a control device that controls the plurality of devices, a user sets a relay device operating system (OS) for each of the plurality of devices. OS s set for the plurality of devices are different from one another in a license, a supported protocol, and hardware control. In PTL 1, for example, each of terminals used by a user determines an OS necessary for a local device and loads the OS from an outside.

### CITATION LIST

### Patent Literature

[PTL 1] Japanese Unexamined Patent Application Publication No. H11-232114

[PTL 2] Japanese Translation of PCT International Application Publication No. 2005-522757

[PTL 3] Japanese Unexamined Patent Application Publication No. 2006-228093

### SUMMARY OF INVENTION

### Technical Problem

Herein, terminals used by a user described in PTL 1 each need to determine an OS to be set for a local device and load the OS from an outside. In such a case, when an OS necessary in reconstruction of a network, resetting of requirements, and the like is changed after an OS is set once, it may be difficult to use the set OS. Further, as in PTL 1, when each of terminals used by a user determines an OS necessary for a local device, it is difficult to set an OS flexibly such that an OS suitable for a newly constructed network is selected or a similar OS is selected in order to cooperate with another device. Therefore, a process of executing resetting for each device by a user may be increased and a process of replacement of a device may occur.

In view of the above-described problems, an object of the present invention is to provide a communication system, a control device, a relay device, a control method, and a program, being capable of flexibly setting an OS for a relay device included in a centralized control-type network.

### Solution to Problem

A communication system according to one aspect of the present invention includes: a plurality of relay devices that relay communication in a network; and a control device that controls the plurality of relay devices, the control device determining, for each of the plurality of relay devices, an OS according to a function of each of the plurality of relay devices, based on information relating to a configuration of the network.

A control device according to one aspect of the present invention includes: OS determination unit for determining, for each of a plurality of relay devices included in a network, an OS according to a function of each of the plurality of relay devices, based on information relating to a configuration of the network; and communication unit for sending a message to notify each of the plurality of relay devices of information relating to the determined OS.

A relay device according to one aspect of the present invention that relays communication in a network, includes: communication unit for receiving an inquiry about whether or not to store information relating to an OS; and OS selection unit for requesting, when not storing information relating to the determined OS, the information relating to the OS.

A control method according to one aspect of the present invention includes: an OS determination step of determining, for each of a plurality of relay devices included in a network, an OS according to a function of each of the plurality of relay devices, based on information relating to a configuration of the network; and a transmission step of sending a message to notify each of the plurality of relay devices of information relating to the determined OS.

A program according to one aspect of the present invention causes a computer to execute: means for determining, for each of a plurality of relay devices included in a network, an OS according to a function of each of the plurality of relay devices, based on information relating to a configuration of the network; and means for sending a message for notification of information relating to the determined OS to each of the plurality of relay devices.

### Advantageous Effects of Invention

According to the communication system, the control device, the control method, and the program of the present invention, an OS can be flexibly set for a relay device included in a centralized control-type network.

### BRIEF DESCRIPTION OF DRAWINGS

FIG. 1 is a diagram illustrating a configuration example of a communication system of a first example embodiment.

FIG. 2 is a block diagram illustrating a configuration example of a control device 100 of the first example embodiment.

FIG. 3 is a diagram illustrating an example of relay device information of the first example embodiment.

FIG. 4 is a diagram illustrating an example of logic network configuration information of the first example embodiment.

FIG. 5 is a block diagram illustrating a configuration example of a relay device 210 of the first example embodiment.

FIG. 6 is a block diagram illustrating a configuration example after a relay device OS selection unit 211 starts a relay device OS unit for downloading 310 in the relay device 210 of the first example embodiment.

FIG. 7 is a block diagram illustrating a configuration example after the relay device OS selection unit 211 starts a relay device OS unit for relaying communication 320 in the relay device 210 of the first example embodiment.

FIG. 8 is a flowchart diagram illustrating an operation example of the control device 100 of the first example embodiment.

FIG. 9 is a flowchart diagram illustrating an operation example of the relay device 210 of the first example embodiment.

FIG. 10 is a sequence diagram illustrating an operation example of network configuration registration of the control device 100 of the first example embodiment.

FIG. 11 is a sequence diagram illustrating an operation example in which the relay device 210 in the first example embodiment installs a relay device OS from the control device 100.

FIG. 12 is a block diagram illustrating a configuration example of a control device 100 of a second example embodiment.

FIG. 13 is a block diagram illustrating a configuration example of a relay device 210 of the second example embodiment.

FIG. 14 is a block diagram illustrating a configuration example after a relay device OS selection unit 211 starts a relay device OS unit for downloading 310 in the relay device 210 of the second example embodiment.

FIG. 15 is a block diagram illustrating another configuration example after the relay device OS selection unit 211 starts the relay device OS for downloading unit 310 in the relay device 210 of the second example embodiment.

FIG. 16 is a flowchart diagram illustrating an operation example of the control device 100 of the second example embodiment.

FIG. 17 is a flowchart diagram illustrating an operation example of the relay device 210 of the second example embodiment.

FIG. 18 is a sequence diagram illustrating an operation example of network configuration registration of the control device 100 of the second example embodiment.

FIG. 19 is a sequence diagram illustrating an operation example in which the relay device 210 in the second example embodiment of the present invention installs a relay device OS from the control device 100.

FIG. 20 is a functional block diagram illustrating a configuration example of a control device 100 in a third example embodiment.

FIG. 21 is a functional block diagram illustrating a configuration example of a relay device 210 in the third example embodiment.

FIG. 22 is a flowchart illustrating an operation example of the control device 100 in the third example embodiment.

### EXAMPLE EMBODIMENT

Example embodiments and examples of the present invention will be described with reference to the drawings. Each example embodiment and each example are illustrative and the present invention is not limited to each example embodiment and each example. Note that, a drawing reference sign in this summary is supplementarily appended to each element for convenience as one example to assist understanding and description of the summary is not intended for any limitation.

### First Example Embodiment

### [Description of a Configuration]

A first example embodiment of the present invention will be described in detail with reference to the drawings.

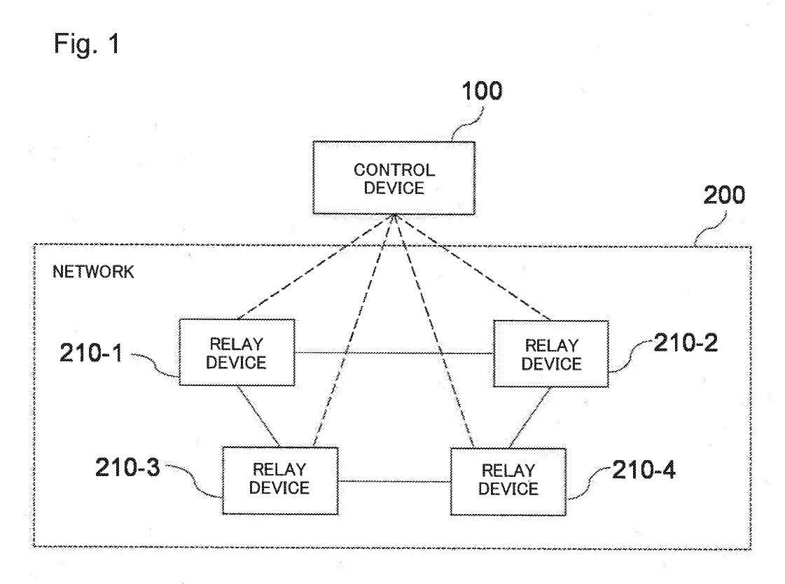

FIG. 1 is a configuration example of a communication system in the first example embodiment. The communication system in the first example embodiment may be any network as long as the network is a centralized control-type network. The communication system in the first example embodiment is, for example, an OpenFlow network.

As illustrated in FIG. 1, the communication system in the first example embodiment includes a control device 100 and a network 200 including a plurality of relay devices 210.

A control link (a dashed line of FIG. 1) is included between the control device 100 and the relay device 210. The control device 100 and the relay device 210 execute, for example, communication via the control link.

A data transfer link (a solid line of FIG. 1) is included among relay devices 210-1, 210-2, 210-3, and 210-4. The relay device 210 executes, for example, transmission/reception of data by using the data transfer link.

However, between the control device 100 and the relay device 210, for example, a control link and a data transfer link may be mixed. When, for example, a data transfer link is included between the control device 100 and the relay device 210, the control device 100 and the relay device 210 may execute communication by using the data transfer link.

Note that, while, in the example of FIG. 1, one control device 100 and four relay devices 210 are included, the numbers of control devices 100 and relay devices 210 are not limited to the numbers of this example and may be any numbers. Further, a topology of a network is not limited to FIG. 1 and may be any shape such as a tandem, a tree, a ring, a mesh, and the like.

The control device 100 makes, when receiving, for example, a Dynamic Host Configuration Protocol (DHCP) query from the relay device 210, a DHCP response corresponding to the relay device 210 having transmitted the DHCP query.

The control device 100 acquires, for example, relay device identification information and logic network configuration information of the relay device 210 from an outside of the control device 100. The control device 100 determines, for example, a relay device operating system (OS) to be downloaded on each relay device 210 by using the relay device identification information and the logic network configuration information of the relay device 210.

The control device 100 inquires of each relay device 210, for example, whether a control program is stored for the relay device OS determined, by the control device 100, to be downloaded on each relay device 210.

The control device 100 transmits, when the relay device OS is not stored on each relay device 210, the control program for the relay device OS to the relay device 210.

The relay device 210 receives, for example, an inquiry about whether a control program is stored for a relay device OS determined, by the control device 100, to be downloaded.

The relay device 210 starts, when, for example, the relay device OS is stored, the relay device OS.

The relay device 210 starts, when the relay device OS is not stored, a relay device OS for downloading and installs the relay device OS.

A relay device OS is, for example, a program corresponding to various types of routing protocols in layer 2 (L2)/layer 3 (L3) switches used by a relay device, a program corresponding to tunneling such as Virtual eXtensible Local Area Network (VxLAN), or a program corresponding to a centralized control protocol such as OpenFlow and the like.

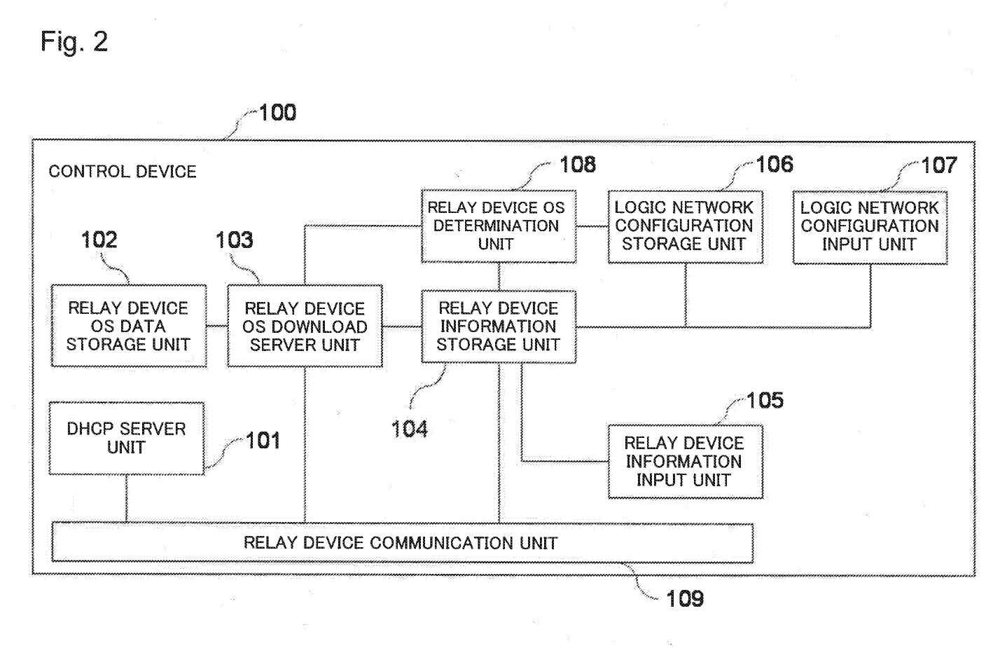

FIG. 2 is a configuration example of the control device 100 in the first example embodiment of the present invention.

The control device 100 includes a DHCP server unit 101, a relay device OS data storage unit 102, a relay device OS download server unit 103, a relay device information storage unit 104, a relay device information input unit 105, a logic network configuration storage unit 106, a logic network configuration input unit 107, a relay device OS determination unit 108, and a relay device communication unit 109.

Note that a solid line for connection from the component 101 to the component 109 of FIG. 2 indicates logical communication or a call ready relation and implementation of the component 101 to the component 109 in the present invention is not limited to a configuration and a network connected by this shape.

The DHCP server unit 101 receives, for example, a DHCP query from the relay device 210 via the relay device communication unit 109. The DHCP server unit 101 generates a DHCP response to the received DHCP query and transmits the DHCP response to the relay device 210 via the relay device communication unit 109.

A DHCP response is information allocated by the control device 100 to the relay device 210 and is, for example, an Internet Protocol (IP) address, a subnet mask or a domain name system (DNS) server address.

In addition, a timing of generating a DHCP response is not limited to a time of reception of a DHCP query, and, for example, may be generated upon connection of the control device 100 and the relay device 210 or may be previously set by a user or another system.

Note that the DHCP server unit 101, for example, may be run by a device independent of the control device 100 or may be run as a function of the relay device communication unit 109.

The relay device OS data storage unit 102 stores control programs for a plurality of relay device OS s downloadable on the relay device 210. The relay device OS data storage unit 102 transmits a control program for a relay device OS in response to a request of the relay device OS download server unit 103. Note that information of a relay device OS stored on the relay device OS data storage unit 102 may store a plurality of versions with respect to the same relay device OS.

The relay device OS download server unit 103 is notified of information of a relay device OS to be downloaded on the relay device 210, from the relay device OS determination unit 108.

The relay device OS download server unit 103 inquires, via the relay device communication unit 109, whether a control program for a relay device OS to be downloaded on the relay device 210 notified from the relay device OS determination unit 108 is stored on the relay device 210. Note that the relay device OS download server unit 103, for example, may transfer a control program for a relay device OS to the relay device 210, without making an inquiry. Further, the relay device OS download server unit 103 may refer to the relay device information storage unit 104 and determine whether a target control program for a relay device OS is stored on the relay device 210.

The relay device OS download server unit 103 receives a download request for a control program for a relay device OS from the relay device 210 via the relay device communication unit 109. As a protocol of a download request received from the relay device 210, for example, HyperText Transfer Protocol (HTTP), IP, TCP, File Transfer Protocol (FTP), or OpenFlow Protocol is used.

The relay device OS download server unit 103 acquires, for example, relay device identification information of the relay device 210 having transmitted a download request from the received download request. The relay device identification information is, for example, a Media Access Control (MAC) address, an IP address, a Transmission Control Protocol (TCP) address, a serial number, or a uniform resource locator (URL) referring to an IP address. Note that an operation for acquiring information that identifies the relay device 210 (hereinafter, relay device identification information) is executed by the relay device OS download server unit 103 without limitation to the unit, or, for example, the relay device communication unit 109 may acquire relay device identification information and transfer the acquired information to the relay device OS download server unit 103.

The relay device OS download server unit 103 acquires, for example, information of a relay device OS to be started by the relay device 210 having transmitted a download request, from the relay device information storage unit 104. Note that the relay device OS download server unit 103, may directly receive, for example, from the relay device OS determination unit 108, information of a relay device OS to be started by the relay device 210 having transmitted the download request or may store, by itself, the information of the relay device OS directly received from the relay device OS determination unit 108 for a certain period.

The relay device OS download server unit 103 acquires, from the relay device OS data storage unit 102, a control program for the relay device OS to be downloaded on the relay device 210.

The relay device OS download server unit 103 transmits the control program for the relay device OS to the relay device 210 having transmitted the download request, via the relay device communication unit 109.

The relay device information storage unit 104 stores information relating to the relay device 210 (hereinafter, relay device information). For example, information input to the relay device information input unit 105 may be acquired as relay device information, and may be generated from a download request and the like received by the relay device communication unit 109.

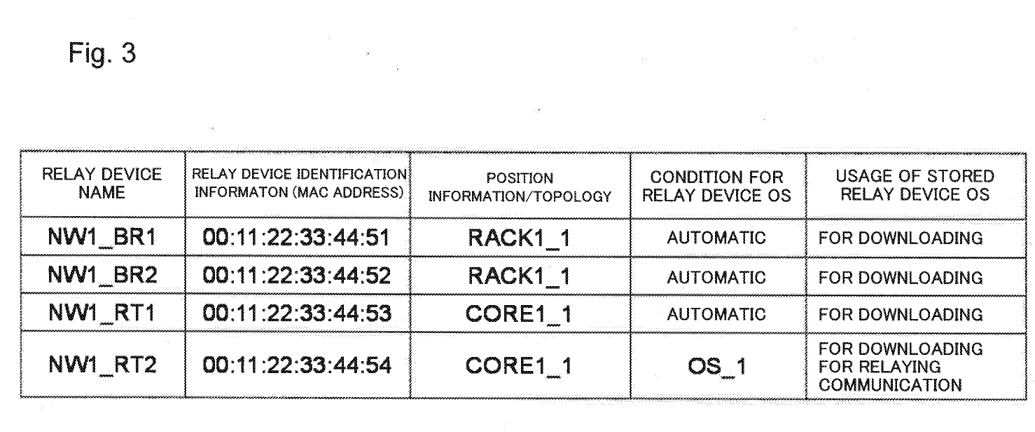

FIG. 3 is a diagram illustrating an example of relay device information stored on the relay device information storage unit 104. As exemplarily illustrated in FIG. 3, relay device information includes, for example, a relay device name, relay device identification information, position information, topology information, a condition for a relay device OS, and a stored relay device OS. Relay device identification information includes, for example, a MAC address, an IP address, a TCP address, a serial number, a URL referring to an IP address. Position information includes, for example, a number of a rack that accommodates the relay device 210 and a floor of a building where a rack is disposed. A condition for a relay device OS includes, for example, a name of a relay device OS needed to be downloaded on the relay device 210, a function necessary for the relay device 210, and an identification number of a relay device OS. A condition for a relay device OS is not limited to information input to the relay device information input unit 105, and a condition for a relay device OS determined by the relay device OS determination unit 108 may be received, for example, from the relay device OS determination unit 108. A stored relay device OS is a name of a relay device OS for which the relay device 210 already stores a control program.

The relay device information input unit 105 executes addition, modification, and deletion of relay device information stored on the relay device information storage unit 104. The relay device information input unit 105 accepts input of relay device information from an outside of the control device 100. The relay device information, for example, may be inputted using a user interface by a user or may be inputted by a high-order server or another system by using REST API.

The relay device information input unit 105 adds, to the relay device information storage unit 104, relay device information input, for example, from an outside of the control device 100. When, for example, relay device information of the same relay device 210 exists on the relay device information storage unit 104, the relay device information input unit 105 may delete previous relay device information and add new relay device information or make a modification by selecting a different item.

The logic network configuration storage unit 106 stores logic network configuration information realized by the relay device 210.

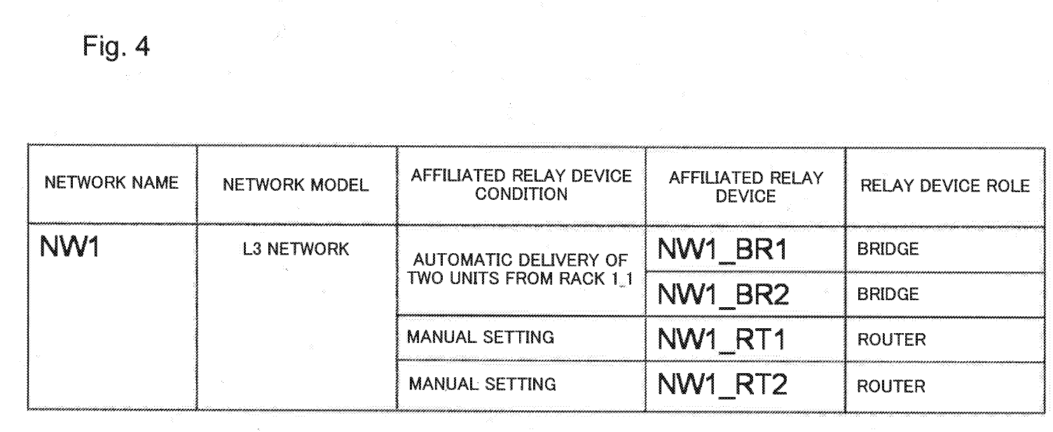

FIG. 4 is a diagram illustrating an example of logic network configuration information stored on the logic network configuration storage unit 106. As exemplarily illustrated in FIG. 4, logic network configuration information includes, for example, a network name, a network model, an affiliated relay device condition, an affiliated relay device, and a relay device role.

A network model includes, for example, an L2 network, an L3 network, QinQ, an L2 network of tunnel communication based on Virtual eXtensible Local Area Network (VxLAN), and an OpenFlow network. Note that, in a logic network configuration, it is possible that, for example, position information of the relay device 210 and a condition such as the number of units are specified and an unused relay device 210 stored on the relay device information storage unit 104 is automatically allocated. Further, in a logic network configuration, it is possible that, for example, a given relay device 210 is specified and allocated to a special application such as a VxLAN gateway.

An affiliated relay device is, for example, relay device identification information of the relay device 210 affiliated with the network 200. As an affiliated relay device, a given relay device 210 may be set using relay device identification information of the relay device 210. An affiliated relay device condition includes, for example, position information of an affiliated relay device, an IP address, a MAC address, and a TCP address. As an affiliated relay device condition, for example, using an IP address and a mask, all relay devices 210 in the network 200 may be affiliated.

In addition, the logic network configuration storage unit 106 does not necessarily store all pieces of input logic network configuration information and may select one of a plurality of network models in which a network name and the control device 100 correspond to each other and register the relay device 210 affiliated with the network, for example, as illustrated in FIG. 4.

The logic network configuration input unit 107 executes addition, modification, and deletion of logic network configuration information stored on the logic network configuration storage unit 106.

The logic network configuration input unit 107 accepts input of logic network configuration information from an outside of the control device 100.

The logic network configuration input unit 107 stores the logic network configuration information received from the outside of the control device 100, for example, on the logic network configuration storage unit 106.

The logic network configuration input unit 107 accepts a generation instruction for a logic network, for example, from an outside of the control device 100.

The logic network configuration input unit 107 requests, when receiving the generation instruction for the logic network from the outside of the control device 100, for example, the relay device OS determination unit 108 to determine a relay device OS.

Note that, as input to the logic network configuration input unit 107, for example, input may be executed by a user by using a user interface or input may be executed by a high-order server or another system by using REST API.

The relay device OS determination unit 108 receives a determination request for a relay device OS from the logic network configuration input unit 107.

The relay device OS determination unit 108 acquires relay device information from the relay device information storage unit 104. The relay device OS determination unit 108 acquires logic network configuration information from the logic network configuration storage unit 106.

The relay device OS determination unit 108 determines, from the relay device information and the logic network configuration information, a relay device OS to be started by the relay device 210 having transmitted a download request.

The relay device OS determination unit 108 stores information of the relay device OS to be started by the relay device 210, for example, on the relay device information storage unit 104. Note that the relay device OS determination unit 108 may not only store information of the relay device OS to be started by the relay device 210 on the relay device information storage unit 104 but also directly notify the relay device OS download server unit 103 of the information.

The relay device communication unit 109 communicates with the relay device 210 via a control link.

A DHCP query is received from the relay device 210. The relay device communication unit 109 transfers the DHCP query received from the relay device 210 to the DHCP server unit 101.

The relay device communication unit 109 receives a DHCP response from the DHCP server unit 101. The relay device communication unit 109 transfers the DHCP response received from the DHCP server unit 101 to the relay device 210 via a control link.

The relay device communication unit 109 receives an inquiry about whether a relay device OS to be started by the relay device 210 is stored on the relay device 210, from the relay device OS download server unit 103. The relay device communication unit 109 transfers the inquiry from the relay device OS download server unit 103 via a control link to the relay device 210.

The relay device communication unit 109 receives a download request for a relay device OS from the relay device 210 via a control link. The relay device communication unit 109 transfers the download request received from the relay device 210 to the relay device OS download server unit 103.

The relay device communication unit 109 receives a control program for a relay device OS from the relay device OS download server unit 103. The relay device communication unit 109 transfers the control program for the relay device OS received from the relay device OS download server unit 103 to the relay device 210 via a control link.

Note that the relay device communication unit 109 may generate relay device identification information of the relay device 210, for example, from a download request for a relay device OS received from the relay device 210 and transfer the generated information to the relay device information storage unit 104.

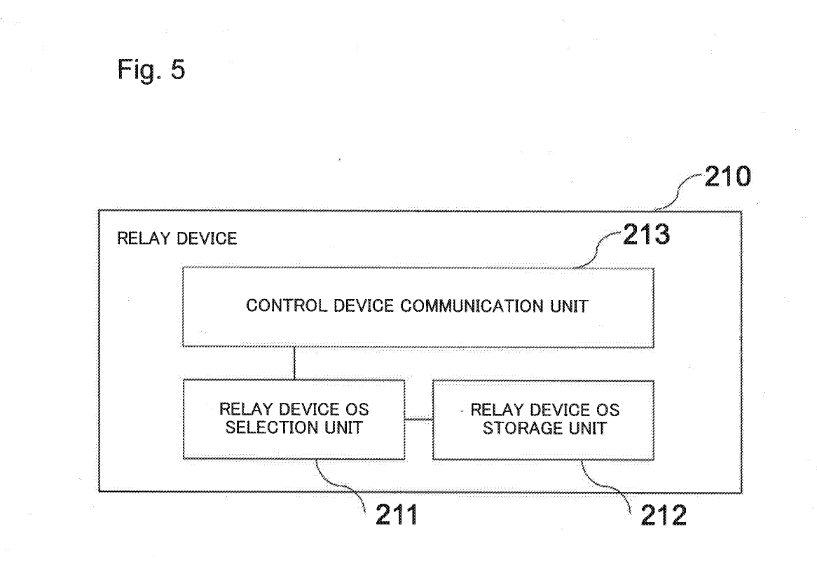

FIG. 5 is a configuration example of the relay device 210 in the first example embodiment of the present invention.

The relay device 210 includes a relay device OS selection unit 211, a relay device OS storage unit 212, and a control device communication unit 213.

Note that a solid line for connection from the component 211 to the component 213 of FIG. 5 indicates logical communication or a call ready relation and implementation of the component 211 to the component 213 in the present invention is not limited to a configuration or a network connected by this shape.

The relay device OS selection unit 211 receives, upon connection of the control device 100 and the relay device 210, for example, information of a relay device OS to be started by the relay device 210 from the control device 100, via the control device communication unit 213. However, notification of information of a relay device OS is not limited to the time of connection of the control device 100 and the relay device 210, and may be made, for example, upon start of the relay device 210 or may be updated upon reception of a request from a user or another system or at every constant time.

The relay device OS selection unit 211 attempts to start, based on information of a relay device OS received from the control device 100, the relay device OS.

When a control program for the relay device OS is stored on the relay device OS storage unit 212, the relay device OS selection unit 211, for example, reads the control program for the relay device OS from the relay device OS storage unit 212 and starts a relay device OS unit.

When a control program for the relay device OS is not stored on the relay device OS storage unit 212, the relay device OS selection unit 211 reads a control program for a relay device OS for downloading, from the relay device OS storage unit 212 and starts the relay device OS unit for downloading 310.

When receiving an installation completion notification from the relay device OS installation unit 313, the relay device OS selection unit 211 starts, from a control program for an installed relay device OS, the relay device OS.

The relay device OS storage unit 212 stores, for example, a control program for a relay device OS to be started by the relay device OS selection unit 211. The relay device OS storage unit 212 can store a control program for a plurality of relay device OS s. Note that a control program for a relay device OS for downloading is previously stored on the relay device OS storage unit 212.

The control device communication unit 213 communicates with the control device 100 via a control link.

The control device communication unit 213 receives, from the control device 100, for example, an inquiry about whether a control program for a relay device OS determined, by the control device 100, to be started in the relay device 210 is stored on the relay device 210.

The control device communication unit 213 transfers the inquiry to the relay device OS selection unit 211.

The control device communication unit 213 receives a DHCP query from a DHCP client unit 311 via a control link. The control device communication unit 213 transfers the DHCP query received from the DHCP client unit 311 to the control device 100.

The control device communication unit 213 receives, for example, a DHCP response from the control device 100 via a control link. The control device communication unit 213 transfers the DHCP response received from the control device 100 to the DHCP client unit 311.

The control device communication unit 213 receives a download request for a relay device OS, for example, from a relay device OS download unit 312. The control device communication unit 213 transfers the download request received from the relay device OS download unit 312 to the control device 100 via a control link.

The control device communication unit 213 receives, for example, a control program for a relay device OS from the control device 100 via a control link. The control device communication unit 213 transfers the control program for the relay device OS received from the control device 100 to the relay device OS download unit 312.

Note that, as network setting of the control device 100, setting of the relay device communication unit 109 is executed. Further, setting of a network may be setting of a communication interface included in the control device 100.

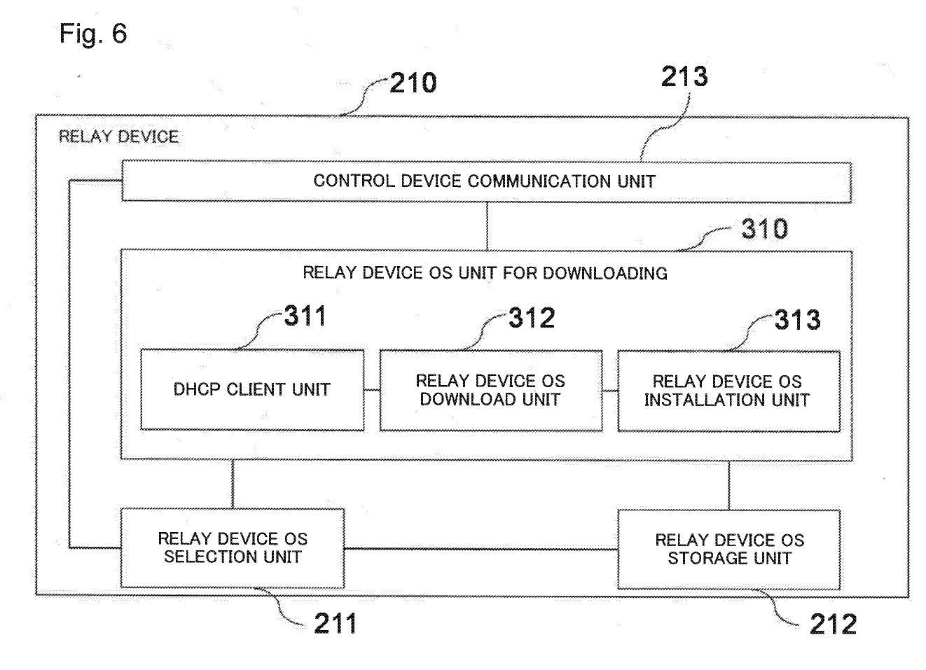

FIG. 6 illustrates a configuration example after the relay device OS selection unit 211 starts the relay device OS unit for downloading 310 in the first example embodiment of the present invention.

The components 211 to 213 of the relay device 210 in the first example embodiment of the present invention are similar to the components 211 to 213 of the relay device 210 exemplarily illustrated in FIG. 5, and therefore detailed description will be omitted.

The relay device OS unit for downloading 310 includes a DHCP client unit 311, a relay device OS download unit 312, and a relay device OS installation unit 313.

Note that a solid line for connection from the component 211 to the component 213 and from the component 310 to the component 313 of FIG. 6 indicates logical communication or a call ready relation and implementation of the component 211 to the component 213 and of the component 310 to the component 313 in the present invention is not limited to a configuration or a network connected by this shape.

The DHCP client unit 311 transmits a DHCP query to the control device 100 via the control device communication unit 213.

The DHCP client unit 311 receives a DHCP response from the control device 100 via the control device communication unit 213. The DHCP response is, for example, an IP address, a subnet mask, a DNS server address, or a default gateway.

The DHCP client unit 311 executes network setting of the relay device 210, based on the DHCP response received from the control device 100. The relay device 210 communicates with the control device 100, for example, based on information of a DHCP response. However, a content of the DHCP response not only may be acquired based on transmission of a DHCP query by the DHCP client unit 311 but also may be previously set by a user or another system.

Note that, as network setting of the relay device 210, setting of the control device communication unit 213 is executed. Further, setting of a network may be setting of a communication interface included in the relay device 210.

The relay device OS download unit 312 transmits a download request for a relay device OS to be started in the relay device 210 to the control device 100 via the control device communication unit 213. As a protocol of a download request received from the relay device 210, for example, HTTP, IP, TCP, or FTP is used.

The relay device OS download unit 312 receives a control program for the relay device OS to be started by the relay device 210 from the control device 100. In other words, the relay device OS download unit 312 downloads a control program for the relay device OS to be started by the relay device 210 from the control device 100.

The relay device OS download unit 312 transfers the downloaded control program for the relay device OS to the relay device OS installation unit 313 and requests the relay device OS installation unit 313 to install the relay device OS.

The relay device OS installation unit 313 receives a control program for a relay device OS from the relay device OS download unit 312.

The relay device OS installation unit 313 converts the control program for the relay device OS received from the relay device OS download unit 312, for example, to a state usable by the relay device 210 and stores the converted program on the relay device OS storage unit 212. In other words, the relay device OS installation unit 313 installs the relay device OS.

Note that storage of a control program on the relay device OS storage unit 212 may be executed, for example, by the relay device OS download unit 312. In this case, in order to start a target relay device OS, for example, the relay device OS unit for downloading 310 is booted and the program is read by the relay device OS installation unit 313.

The relay device OS installation unit 313 manages a control program for a relay device OS stored on the relay device OS storage unit 212. The relay device OS installation unit 313 executes, for example, addition, modification, and deletion of a control program for a relay device OS stored on the relay device OS storage unit 212. Note that a control program for a relay device OS stored on the relay device OS storage unit 212 may be managed by the relay device OS installation unit 313 when, for example, a control program for a new relay device OS is added, may be deleted by setting a validated date, or may be deleted periodically.

Note that the control device 100 may include an installation program in a control program for a relay device OS received from the relay device OS download unit 312 and the relay device OS installation unit 313 may read and install the program.

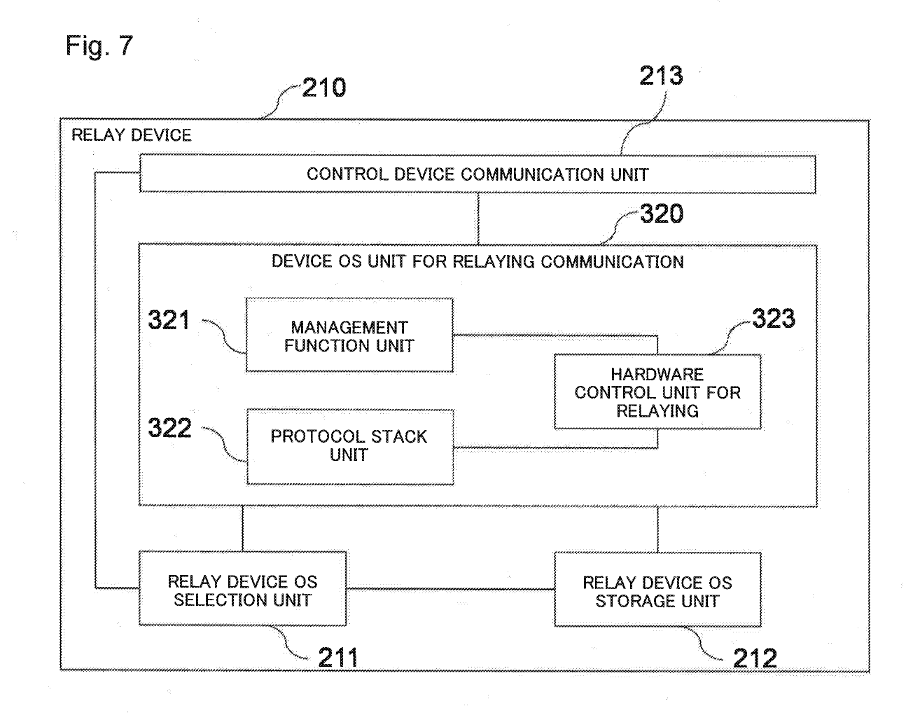

The relay device OS installation unit 313 transmits an installation completion notification to the relay device OS selection unit 211 after installation of the relay device OS is completed. FIG. 7 illustrates a configuration example after the relay device OS selection unit 211 starts a relay device OS unit for relaying communication 320 in the first example embodiment of the present invention. Note that the relay device OS unit for relaying communication 320 is one example of a relay device OS to be downloaded on the relay device 210 from the control device 100 but thereby, a relay device OS to be downloaded on the relay device 210 is not limited. A configuration of a relay device OS to be downloaded on the relay device 210 from the control device 100 is changed, for example, depending on a relay/termination function of communication realized by the relay device OS in the relay device 210.

The relay device OS unit for relaying communication 320 includes a management function unit 321, a protocol stack unit 322, and a hardware control unit for relaying 323.

The management function unit 321 executes, for example, a configuration for communication relay. The configuration executed by the management function unit 321 is, for example, setting of an IP address, a protocol, and a host name.

The management function unit 321 notifies the hardware control unit for relaying 323 of a result of the configuration.

The protocol stack unit 322 stores a protocol stack where a protocol for relaying communication is hierarchically stacked. The protocol stack unit 322 exchanges, for example, a network protocol between relay devices 210. The protocol stack unit 322 stores a protocol acquired from another relay device 210 in a protocol stack.

The protocol stack unit 322 notifies the hardware control unit for relaying 323 of a content stored in a protocol stack.

The hardware control unit for relaying 323 receives a setting result of the configuration from the management function unit 321. The hardware control unit for relaying 323 receives a storage content of a protocol from the protocol stack unit 322.

The hardware control unit for relaying 323 executes hardware setting of the relay device 210 from the setting result of the configuration and the storage content of the protocol.

[Description of an Operation]

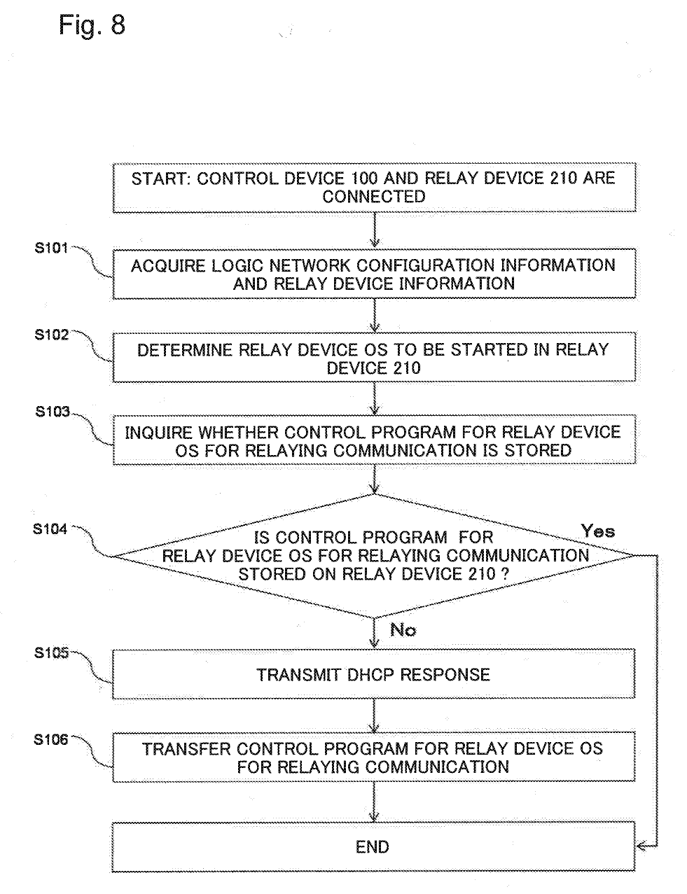

An operation for executing automatic provisioning for the relay device 210 by the control device 100 in the first example embodiment of the present invention will be described with reference to FIG. 8.

FIG. 8 is a flowchart illustrating an example of an operation of the control device 100 of the first example embodiment of the present invention. In the following, a case where the control device 100 determines, for the relay device 210, to start the relay device OS unit for relaying communication 320 will be described as an example.

The control device 100 is connected to the relay device 210.

The control device 100 acquires logic network configuration information from a user or another system via the logic network configuration input unit 107. The control device 100 acquires relay device information from a user or another system via the relay device information input unit 105 (S101).

The control device 100 determines to start, from the logic network configuration information and the relay device information, a relay device OS for relaying communication as a relay device OS to be started in the relay device 210 (S102).

The control device 100 inquires whether a control program for the relay device OS for relaying communication is stored on the relay device 210 (S103).

When a control program for the relay device OS for relaying communication is stored on the relay device 210 (Yes of S104), the relay device OS unit for relaying communication 320 is started in the relay device 210.

When a control program for the relay device OS for relaying communication is not stored on the relay device 210 (No of S104), the control device 100 receives a DHCP query from the relay device 210 and transmits a DHCP response as a response (S105).

The control device 100 receives, from the relay device 210, a download request for the relay device OS for relaying communication and transfers, to the relay device 210, as a response, a control program for the relay device OS for relaying communication (S106).

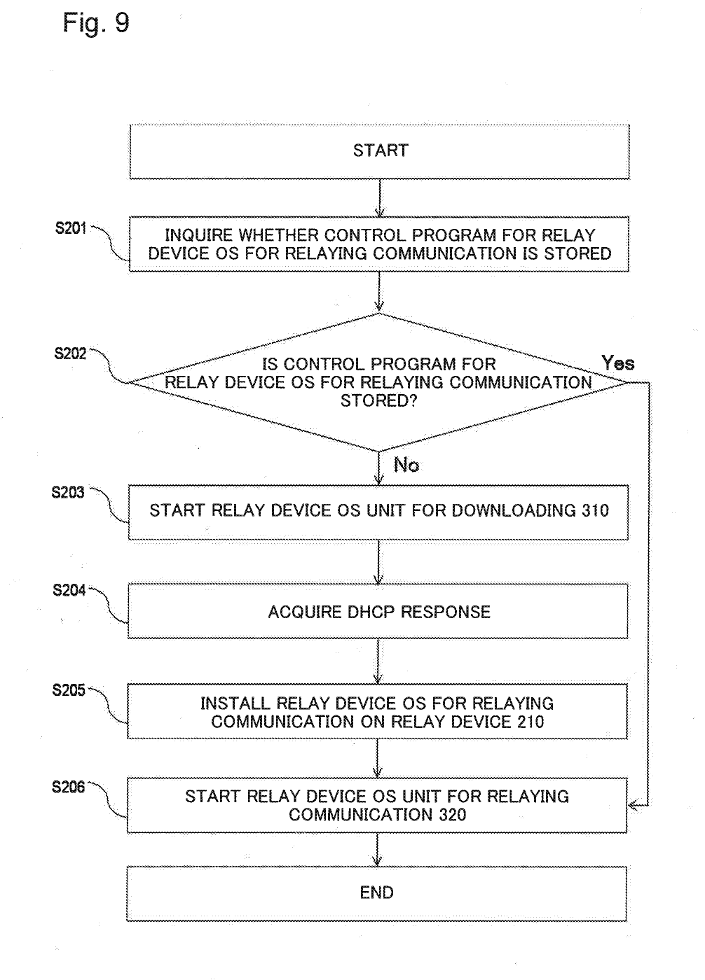

An operation in which the relay device 210 is subjected to automatic provisioning by the control device 100 in the first example embodiment of the present invention will be described with reference to FIG. 9.

FIG. 9 is a flowchart illustrating an example of an operation of the relay device 210 of the first example embodiment of the present invention.

The relay device 210 is connected to the control device 100.

The relay device 210 receives, from the control device 100, an inquiry about whether a control program is stored for a relay device OS for relaying communication (S201).

When a control program for the relay device OS for relaying communication is stored on the relay device 210 (Yes of S202), the relay device 210 starts the relay device OS unit for relaying communication 320.

When a control program for the relay device OS for relaying communication is not stored on the relay device 210 (No of S202), the relay device 210 starts the relay device OS unit for downloading 310 (S203).

The relay device 210 transmits a DHCP query to the control device 100 and acquires a DHCP response as a response (S204).

The relay device 210 requests the control device 100 to download the relay device OS for communication. The relay device 210 acquires, as a response to the download request, a control program for the relay device OS for communication, from the control device 100 and installs the acquired control program (S205).

The relay device 210 starts the relay device OS unit for relaying communication 320 from the installed control program for the relay device OS for communication (S206).

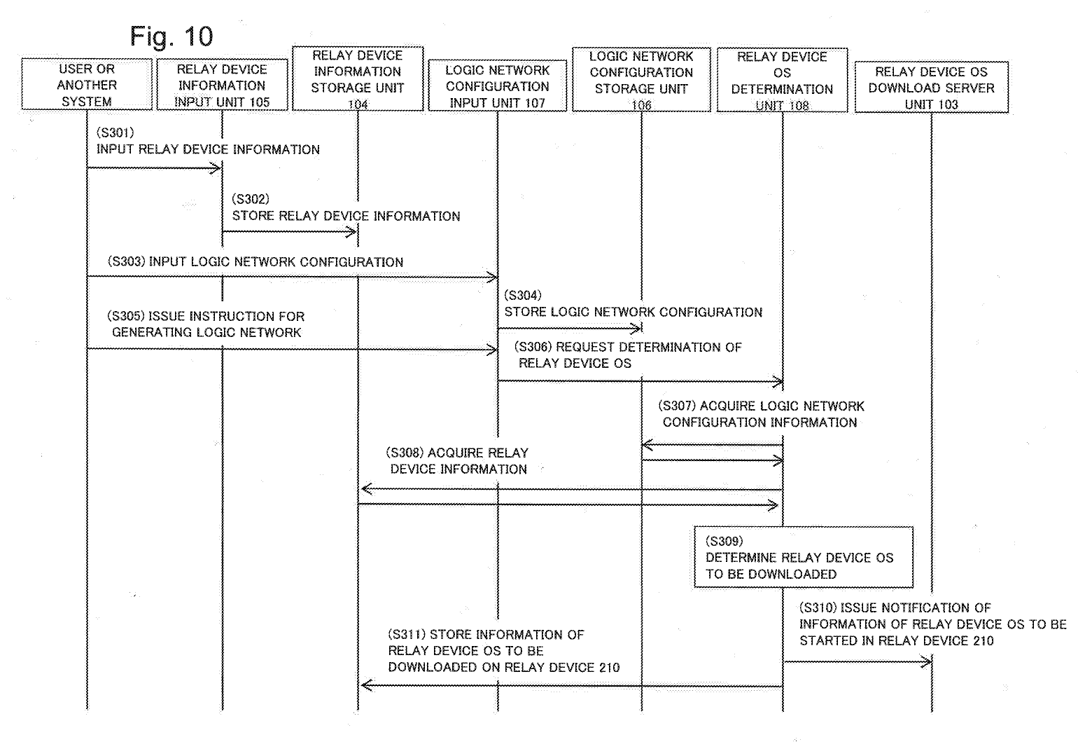

An operation of the control device 100 in the first example embodiment of the present invention will be described in detail with reference to FIG. 10.

FIG. 10 is a sequence diagram illustrating an operation example of network configuration registration of the control device 100 in the first example embodiment of the present invention.

The relay device information input unit 105 accepts, for example, input of relay device information from a user or another system (S301).

The relay device information input unit 105 stores the relay device information input from the user or another system on the relay device information storage unit 104 (S302).

The logic network configuration input unit 107 accepts input of logic network configuration information from a user or another system (S303).

The logic network configuration input unit 107 stores the logic network configuration information input from the user or another system on the logic network configuration storage unit 106 (S304).

The logic network configuration input unit 107 accepts an instruction for logic network generation from a user or another system (S305).

The logic network configuration input unit 107 requests, when receiving the instruction for logic network generation from the user or another system, the relay device OS determination unit 108 to determine a relay device OS (S306).

The relay device OS determination unit 108 acquires logic network configuration information from the logic network configuration storage unit 106 (S307).

The relay device OS determination unit 108 acquires relay device information from the relay device information storage unit 104 (S308).

The relay device OS determination unit 108 determines a relay device OS to be started in the relay device 210 from the acquired logic network configuration information and relay device information (S309).

The relay device OS determination unit 108 notifies the relay device OS download server unit 103 of information of the relay device OS to be started in the relay device 210 (S310).

The relay device OS determination unit 108 stores the information of the relay device OS to be started in the relay device 210 on the relay device information storage unit 104 (S311).

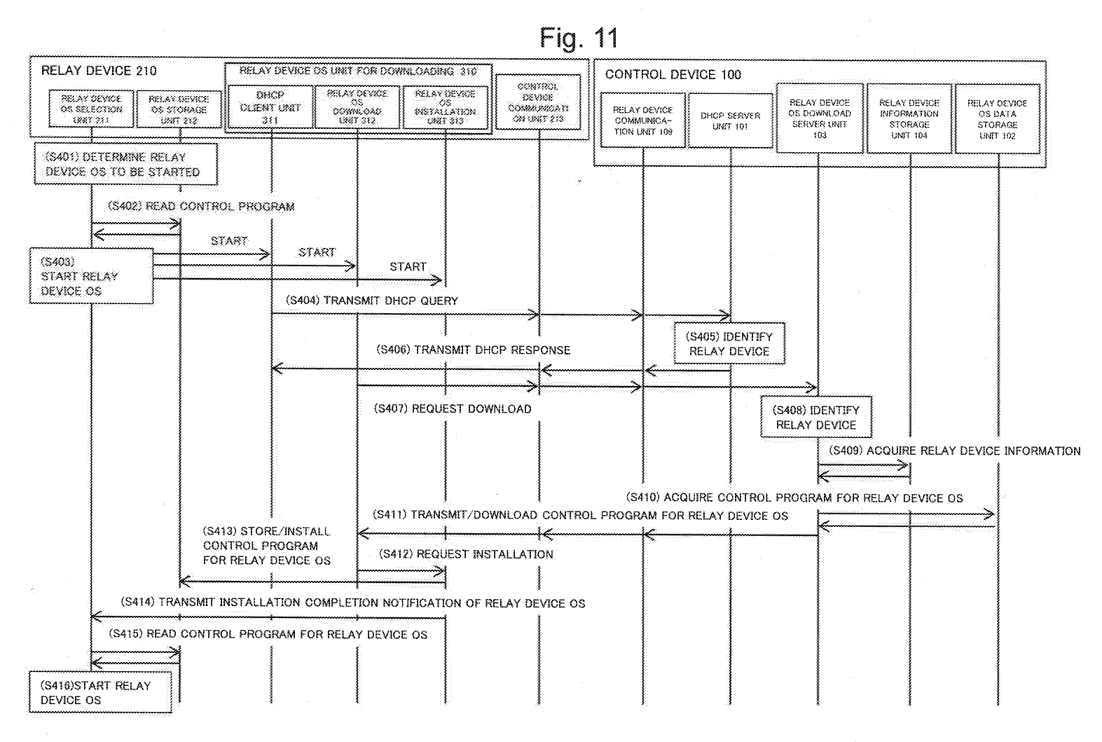

An operation in which the relay device 210 installs a relay device OS from the control device 100 in the first example embodiment of the present invention will be described with reference to FIG. 11.

FIG. 11 is a sequence diagram illustrating an operation example in which the relay device 210 installs a relay device OS from the control device 100 in the first example embodiment of the present invention. In the following, a case where a control program for a relay device OS for relaying communication is not stored on the relay device 210 will be described as an example.

The relay device OS selection unit 211 receives, from the control device 100, information of a relay device OS (relay device OS for relaying communication) determined, by the control device 100, to be started in the relay device 210. The relay device OS selection unit 211 attempts to start the relay device OS for relaying communication. In this case, a control program for the relay device OS for relaying communication is not stored on the relay device OS storage unit 212 by the relay device 210 and therefore the relay device 210 determines to start a relay device OS for downloading (S401).

The relay device OS selection unit 211 reads a control program for the relay device OS for downloading, from the relay device OS storage unit 212 (S402).

The relay device OS selection unit 211 starts the relay device OS unit for downloading 310 from the control program for the relay device OS for downloading read from the relay device OS storage unit 212 (S403).

In the relay device OS unit for downloading 310, the DHCP client unit 311 transmits a DHCP query to the DHCP server unit 101 of the control device 100 via the control device communication unit 213 and the relay device communication unit 109 (S404).

The DHCP server unit 101 identifies, from the DHCP query received from the DHCP client unit 311, the relay device 210 having transmitted the DHCP query (S405).

The DHCP server unit 101 allocates information necessary for communication to the relay device 210 having transmitted the DHCP query, collects the allocated information as a DHCP response, and transmits the collected DHCP response to the DHCP client unit 311 via the control device communication unit 213 and the relay device communication unit 109 (S406).

The relay device OS download unit 312 requests the relay device OS download server unit 103 to download a relay device OS via the control device communication unit 213 and the relay device communication unit 109, based on previously stored information of a download request destination (control device 100) such as a URL (S407).

The relay device OS download server unit 103 identifies, from a download request received from the relay device 210, the relay device 210 having transmitted the download request (S408).

The relay device OS download server unit 103 acquires, from the relay device information storage unit 104, relay device information of the relay device 210 having transmitted the download request for the relay device OS (S409). The relay device OS download server unit 103 determines, from the relay device information, that the relay device OS to be started by the relay device 210 is a relay device OS for relaying communication.

The relay device OS download server unit 103 acquires a control program for the relay device OS for relaying communication, from the relay device OS data storage unit 102 (S410).

The relay device OS download server unit 103 transmits the control program for the relay device OS for relaying communication, to the relay device OS download unit 312. The relay device OS download unit 312 receives (downloads) the control program for the relay device OS for relaying communication, from the relay device OS download server unit 103 via the control device communication unit 213 and the relay device communication unit 109 (S411).

The relay device OS download unit 312 requests the relay device OS installation unit 313 to install the relay device OS for relaying communication, the relay device OS being received from the relay device OS download server unit 103 (S412).

The relay device OS installation unit 313 stores (installs) the control program for the relay device OS for relaying communication, on the relay device OS storage unit 212 (S413).

The relay device OS installation unit 313 transmits, when completing the installation, an installation completion notification to the relay device OS selection unit 211 (S414).

The relay device OS selection unit 211 reads, when receiving the installation completion notification from the relay device OS installation unit 313, a control program for a relay device OS from the relay device OS storage unit 212 (S415).

The relay device OS selection unit 211 starts the relay device OS unit for relaying communication 320 from the installed control program for the relay device OS (S416).

In the following, an operation example in which the relay device 210 starts the relay device OS unit for relaying communication 320 will be described.

After the relay device OS unit for relaying communication 320 is started, the management function unit 321 executes a configuration of the relay device 210.

The management function unit 321 transfers a result of the configuration to the hardware control unit for relaying 323.

The protocol stack unit 322 exchanges a protocol, for example, with another relay device 210.

The protocol stack unit 322 stores a protocol acquired from another relay device 210.

The protocol stack unit 322 transfers a content of the stored protocol to the hardware control unit for relaying 323.

The hardware control unit for relaying 323 receives the result of the configuration from the management function unit 321.

The hardware control unit for relaying 323 receives the storage content of the protocol from the protocol stack unit 322.

The hardware control unit for relaying 323 executes hardware setting of the relay device 210 from the result of the configuration and the storage content of the protocol.

### [Description of Advantageous Effects]

As described above, in the first example embodiment of the present invention, relay device information and logic network configuration information are input to the control device 100, and thereby the control device 100 determines a relay device OS to be started in the relay device 210. The relay device 210 issues a request to the control device 100 when a control program for the relay device OS does not exist on the local device and installs the control program on the local device. Thereby, the control device 100 can execute automatic provisioning for the relay device 210. Therefore, it is unnecessary for a user to execute relay device OS setting for logic network construction by him/herself, and thereby construction of a network can be simplified.

Further, provisioning can be automatically executed by the control device 100, and therefore a role of the relay device 210 can be more rapidly modified than in a case where a user executes setting.

Further, in the first example embodiment of the present invention, the relay device 210 can select and install a relay device OS necessary for the local device. Therefore, the relay device 210 can execute various types of processings by using a smaller data capacity than in a case where all control programs for relay device OS s that may be used are previously stored.

### Second Example Embodiment

### [Description of a Configuration]

A second example embodiment of the present invention will be described in detail with reference to the drawings. Note that a technique of the second example embodiment is also applicable to any one of the first example embodiment and an example embodiment to be described later.

A configuration example of a communication system of the second example embodiment is similar to the configuration example of the communication system of the first example embodiment exemplarily illustrated in FIG. 1, and therefore detailed description will be omitted.

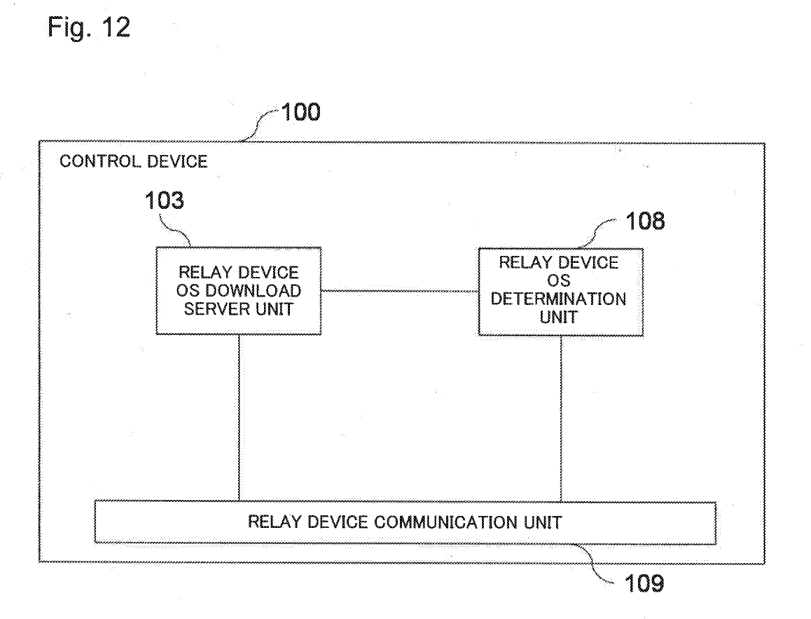

FIG. 12 is a configuration example of a control device 100 in the second example embodiment of the present invention.

The control device 100 includes a relay device OS download server unit 103, a relay device OS determination unit 108, and a relay device communication unit 109.

Note that a solid line connecting the components 103, 108, and 109 of FIG. 12 indicates logical communication or a call ready relation and implementation of the components 103, 108, and 109 in the present invention is not limited to a configuration or a network connected by this shape.

The relay device OS download server unit 103 is notified of information of a relay device OS to be downloaded on a relay device 210, from the relay device OS determination unit 108.

The relay device OS download server unit 103 inquires whether a control program for the relay device OS to be downloaded on the relay device 210 notified from the relay device OS determination unit 108 is stored on the relay device 210, via the relay device communication unit 109.

The relay device OS download server unit 103 receives a download request for a control program for the relay device OS from the relay device 210, via the relay device communication unit 109. As a protocol of the download request received from the relay device 210, for example, HTTP, IP, TCP, or FTP is used.

The relay device OS download server unit 103 acquires, from the received download request, for example, relay device identification information of the relay device 210 having transmitted the download request. The relay device identification information is, for example, a MAC address, an IP address, a TCP address, a serial number, or a URL referring to an IP address. Note that execution of an operation for acquiring relay device identification information is not limited to the relay device OS download server unit 103, and for example, the relay device communication unit 109 may acquire relay device identification information and transfer the acquired information to the relay device download server unit 103.

The relay device download server unit 103 transmits the control program for the relay device OS to the relay device 210 having transmitted the download request, via the relay device communication unit 109.

The relay device OS determination unit 108 accepts, for example, input of relay device information from a user or another system.

The relay device OS determination unit 108 accepts, for example, input of a logic network configuration from a user or another system.

The relay device OS determination unit 108 accepts, for example, a generation instruction for a logic network from a user or another system.

The relay device OS determination unit 108 determines, when receiving, for example, a generation instruction for a logic network from a user or another system, a relay device OS to be started by the relay device 210 from the relay device information and the logic network configuration information.

The relay device OS determination unit 108 notifies the relay device OS download server unit 103 of information of the relay device OS to be started by the relay device 210.

The relay device communication unit 109 communicates with the relay device 210 via a control link.

The relay device communication unit 109 receives an inquiry about whether a relay device OS to be started in the relay device 210 is stored on the relay device 210, from the relay device OS download server unit 103. The relay device communication unit 109 transfers the inquiry from the relay device OS download server unit 103 to the relay device 210, via a control link.

The relay device communication unit 109 receives a download request for a relay device OS from the relay device 210 via a control link. The relay device communication unit 109 transfers the download request received from the relay device 210 to the relay device OS download server unit 103.

The relay device communication unit 109 receives a control program for the relay device OS from the relay device OS download server unit 103. The relay device communication unit 109 transfers the control program for the relay device OS received from the relay device OS download server unit 103 to the relay device 210 via a control link.

Note that the relay device communication unit 109 may acquire, for example, relay device identification information of the relay device 210 from a download request for a relay device OS received from the relay device 210 and transfer the acquired information to the relay device OS download server unit 103.

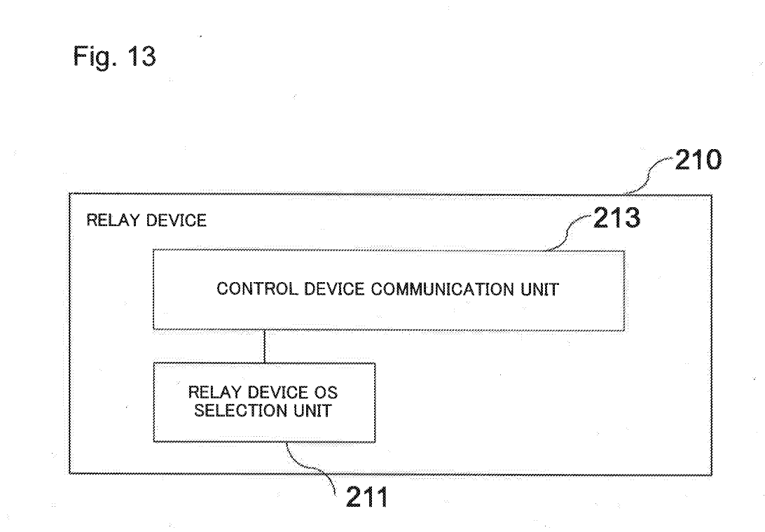

FIG. 13 illustrates a configuration example of the relay device 210 in the second example embodiment of the present invention.

The relay device 210 includes a relay device OS selection unit 211 and a control device communication unit 213.

Note that a solid line connecting the components 211 and 213 of FIG. 13 indicates logical communication or a call ready relation and implementation of the components 211 and 213 in the present invention is not limited to a configuration or a network connected by this shape.

The relay device OS selection unit 211 receives, upon connection of the control device 100 and the relay device 210, for example, information of a relay device OS to be started in the relay device 210 from the control device 100, via the control device communication unit 213. However, a notification of information of a relay device OS is not limited to the time of connection of the control device 100 and the relay device 210, and may be made, for example, upon start of the relay device 210 or may be updated upon reception of a request from a user or another system or at every constant time.

The relay device OS selection unit 211 attempts to start, based on information of a relay device OS received from the control device 100, a control program for a relay device OS to be started in the relay device 210.

When a control program for the relay device OS is stored on the relay device 210, the relay device OS selection unit 211, for example, reads the control program for the relay device OS and starts a relay device OS unit.

When information of the relay device OS is not stored on the relay device 210, the relay device OS selection unit 211 reads a control program for a relay device OS for downloading and starts the relay device OS unit for downloading 310.

When receiving an installation completion notification from the relay device OS installation unit 313, the relay device OS selection unit 211 starts, from the installed control program for an relay device OS, the relay device OS.

The control device communication unit 213 communicates with the control device 100 via a control link.

The control device communication unit 213 receives, from the control device 100, for example, an inquiry about whether a control program for a relay device OS determined, by the control device 100, to be started in the relay device 210 is stored on the relay device 210.

The control device communication unit 213 transfers the inquiry to the relay device OS selection unit 211.

The control device communication unit 213 receives, for example, a download request for a relay device OS from the relay device OS download unit 312. The control device communication unit 213 transfers the download request received from the relay device OS download unit 312 to the control device 100.

The control device communication unit 213 receives a control program for the relay device OS from the control device 100. The control device communication unit 213 transfers the control program for the relay device OS received from the control device 100 to the relay device OS download unit 312.

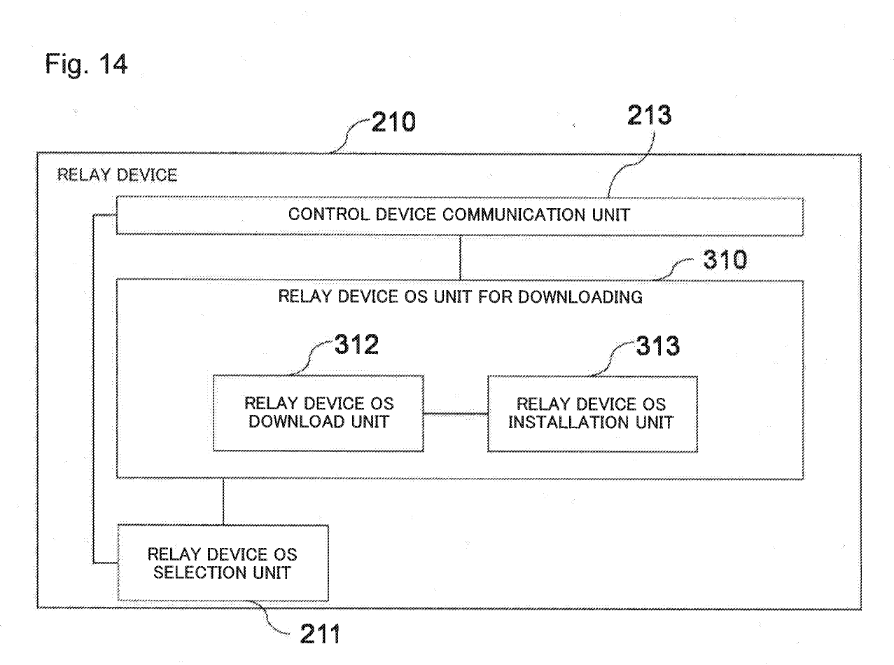

FIG. 14 illustrates a configuration example after the relay device OS selection unit 211 starts the relay device OS unit for downloading 310 in the second example embodiment of the present invention.

The relay device 210 includes a relay device OS selection unit 211, a control device communication unit 213, and a relay device OS unit for downloading 310.

Note that a solid line connecting the components 211, 213, 310, 312, and 313 of FIG. 14 indicates logical communication or a call ready relation and implementation of the components 211, 213, 310, 312, and 313 in the present invention is not limited to a configuration or a network connected by this shape.

Further, the components 211 and 213 of the relay device 210 in the second example embodiment of the present invention are similar to the components 211 to 213 of the relay device 210 exemplarily illustrated in FIG. 13, and therefore detailed description will be omitted.

The relay device OS unit for downloading 310 includes a relay device OS download unit 312 and a relayed device OS installation unit 313.

The relay device OS download unit 312 transmits a download request for a relay device OS to be started by the relay device 210 to the control device 100, via the control device communication unit 213. As a protocol of the download request received from the relay device 210, for example, HTTP, IP, TCP, or FTP is used.

The relay device OS download unit 312 receives a control program for a relay device OS to be started by the relay device 210 from the control device 100. In other words, the relay device OS download unit 312 downloads a control program for a relay device OS from the control device 100.

The relay device OS download unit 312 transfers the downloaded control program for the control device OS to the relay device OS installation unit 313 and requests the relay device OS installation unit 313 to install the relay device OS.

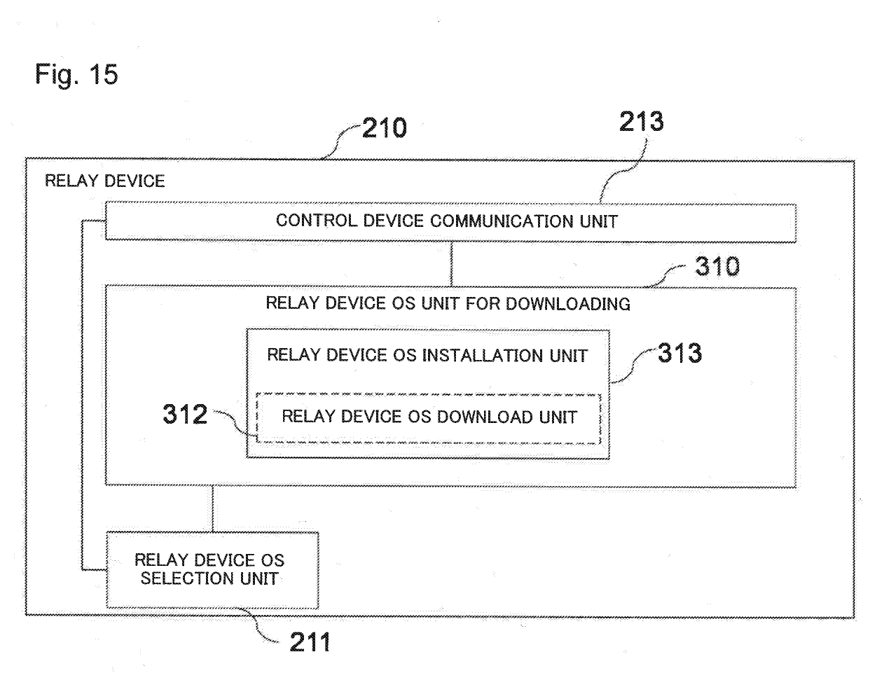

Note that the relay device OS download unit 312 may be run as a function of the relay device OS installation unit 313, for example, as in FIG. 15.

The relay device OS installation unit 313 receives a control program for a relay device OS from the relay device OS download unit 312.

The relay device OS installation unit 313 converts the control program for the relay device OS received from the relay device OS download unit 312, for example, to a state usable by the relay device 210. In other words, the relay device OS installation unit 313 installs a relay device OS.

Note that the control device 100 may include an installation program in a control program for a relay device OS received from relay device OS download unit 312 and the relay device OS installation unit 313 may read and install the program.

The relay device OS installation unit 313 transmits an installation completion notification to the relay device OS selection unit 211 after installation of the relay OS is completed.

### [Description of an Operation]

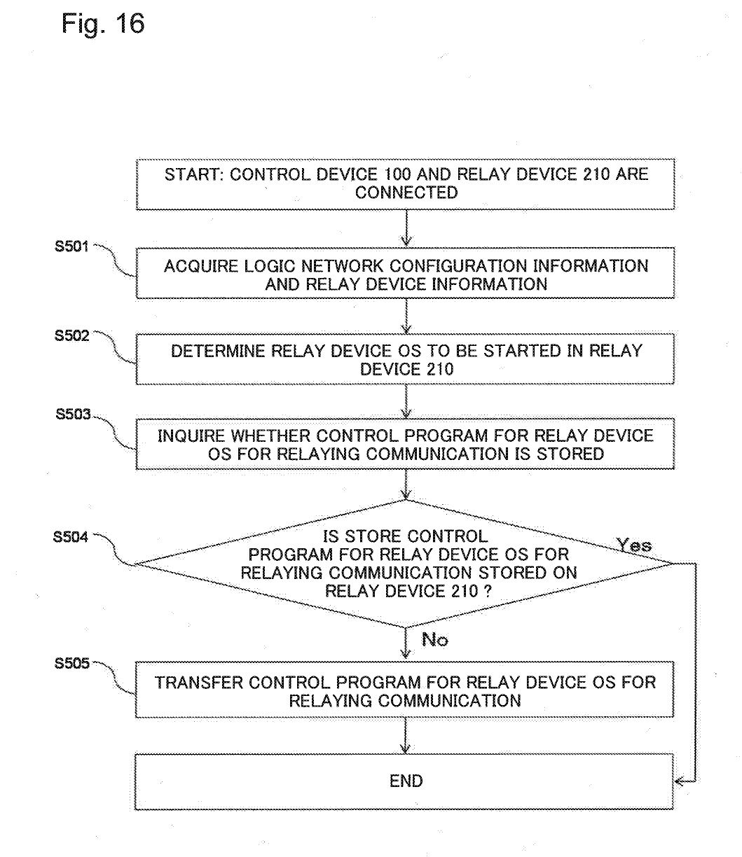

An operation for executing automatic provisioning for the relay device 210 by the control device 210 in the second example embodiment of the present invention will be described with reference to FIG. 16.

FIG. 16 is a flowchart illustrating an example of an operation of the control device 100 of the second example embodiment of the present invention. In the following, a case where the control device 100 determines, for the relay device 210, to start a relay device OS unit for relaying communication 320 will be described.

The control device 100 is connected to the relay device 210.

The control device 100 acquires logic network configuration information from a user or another system. The control device 100 acquires relay device information from a user or another system (S501).

The control device 100 determines to start a relay device OS for relaying communication as a relay device OS to be started in the relay device 210 from logic network configuration information and the relay device information (S502).

The control device 100 inquires whether a control program for a relay device OS for relaying communication is stored on the relay device 210 (S503).

When a control program for the relay device OS for relaying communication is stored on the relay device 210 (Yes of S504), a relay device OS unit for relaying communication 320 is started in the relay device 210.

When a control program for the relay device OS for relaying communication is not stored on the relay device 210 (No of S504), the control device 100 receives a download request from the relay device 210 and transfers a control program for the relay device OS for relaying communication as a response (S505).

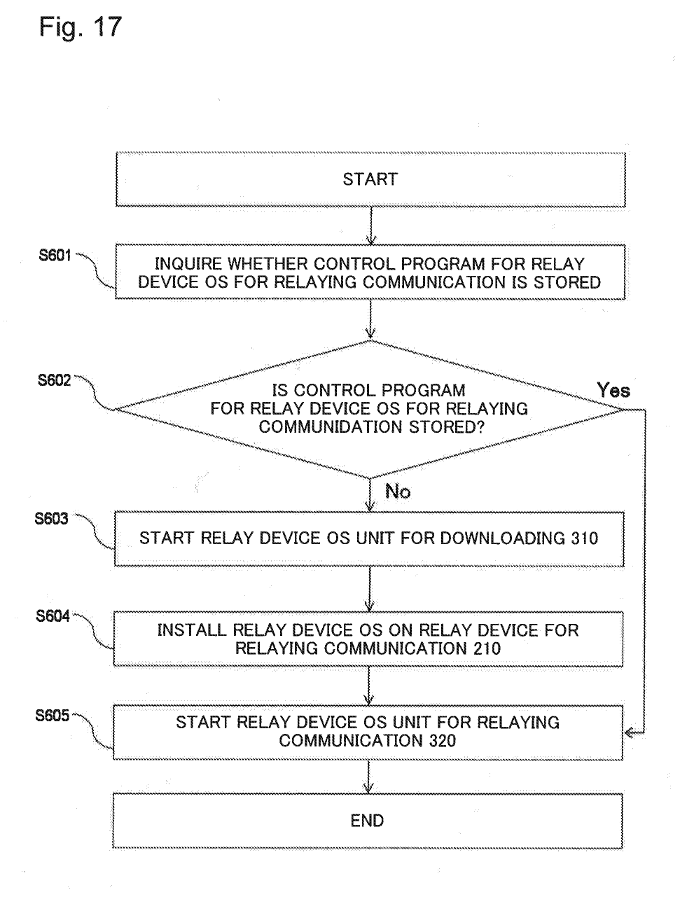

An operation in which the relay device 210 is subjected to automatic provisioning by the control device 100 in the second example embodiment of the present invention will be described with reference to FIG. 17.

FIG. 17 is a flowchart illustrating an example of an operation of the relay device 210 of the second example embodiment of the present invention.

The relay device 210 is connected to the control device 100.

The relay device 210 receives an inquiry whether a control program is stored for a relay device OS for relaying communication, from the control device 100 (S601).

When a control program for the relay device OS for relaying communication is stored on the relay device 210 (Yes of S602), the relay device 210 starts the relay device OS unit for relaying communication 320.

When a control program for the relay device OS for relaying communication is not stored on the relay device 210 (No of S602), the relay device 210 starts the relay device OS unit for downloading 310 (S603).

The relay device 210 requests the control device 100 to download the relay device OS for communication. The relay device 210 acquires, as a response to the download request, a control program for the relay device OS for communication, from the control device 100 and installs the acquired control program (S604).

The relay device 210 starts the relay device OS unit for relaying communication 320 from the installed control program for the relay device OS for relaying communication (S605).

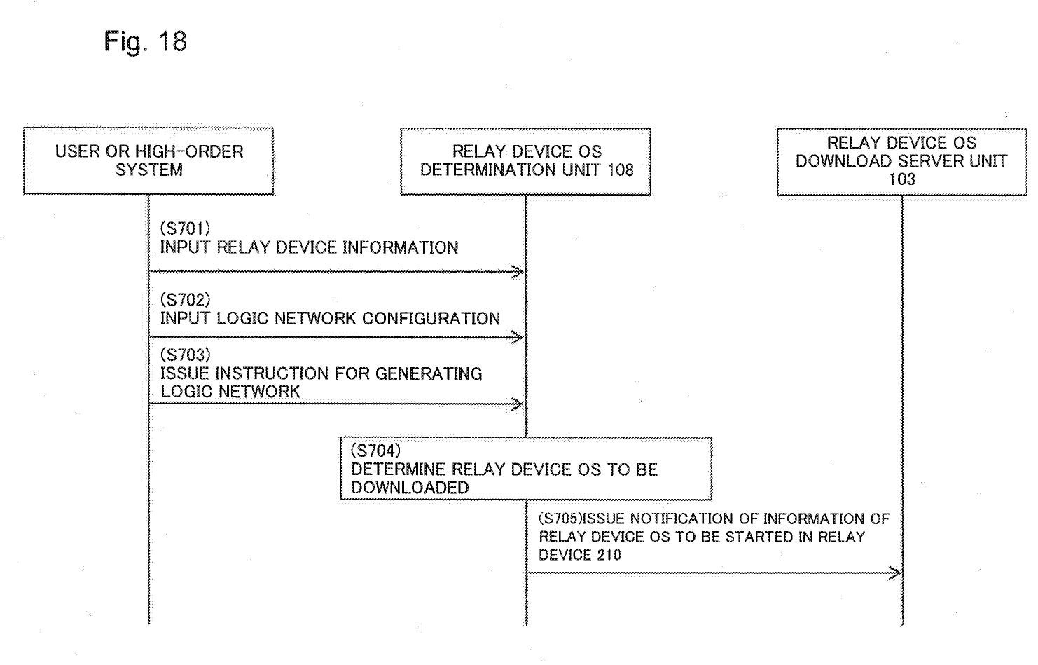

An operation of the control device 100 in the second example embodiment of the present invention will be described in detail with reference to FIG. 18.

FIG. 18 is a sequence diagram illustrating an operation example of network configuration registration of the control device 100 in the first example embodiment of the present invention.

The relay device OS determination unit 108 accepts input of relay device information from a user or another system (S701).

The relay device OS determination unit 108 accepts input of logic network configuration information from a user or another system (S702).

The relay device OS determination unit 108 accepts an instruction for logic network generation from a user or another system (S703).

The relay device OS determination unit 108 determines a relay device OS to be started in the relay device 210, from the acquired relay device information and logic network configuration information (S704).

The relay device OS determination unit 108 notifies the relay device OS download server unit 103 of information of the relay device OS to be started in the relay device 210 (S705).

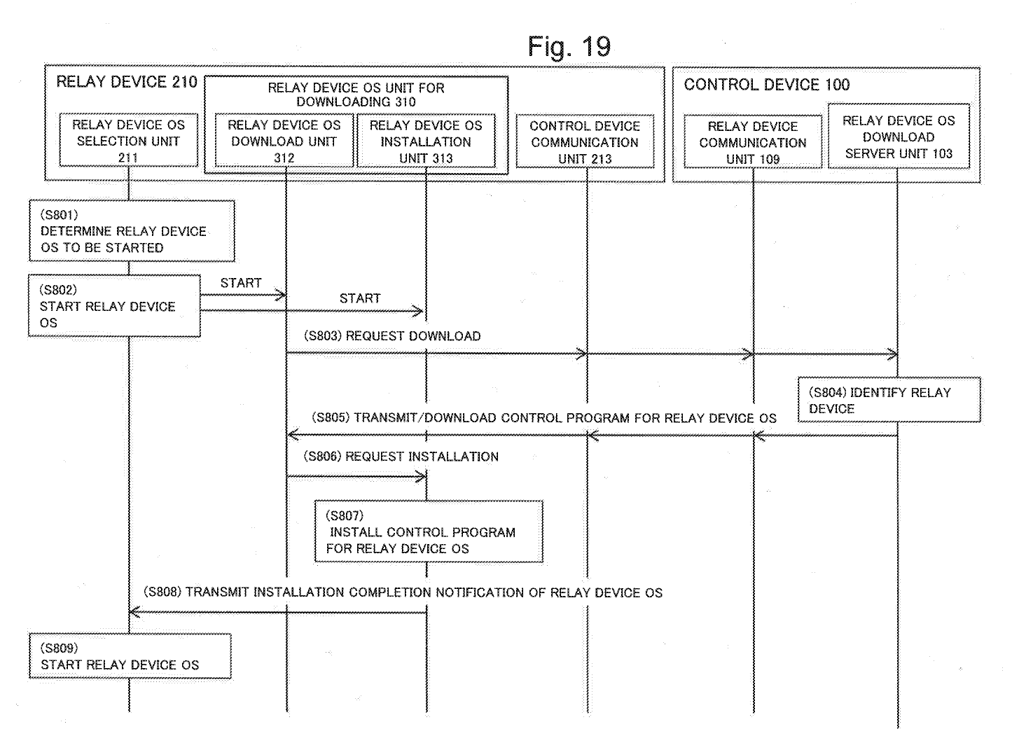

An operation in which the relay device 210 installs a relay device OS from the control device 100 in the second example embodiment of the present invention will be described with reference to FIG. 19.

FIG. 19 is a sequence diagram illustrating an operation example in which the relay device 210 installs a relay device OS from the control device 100 in the first example embodiment of the present invention. In the following, a case where a control program for a relay device OS for relaying communication is not stored on the relay device 210 will be described.

The relay device OS selection unit 211 receives, from the control device 100, information of a relay device OS (relay device OS for relaying communication) determined, by the control device 100, to be started in the relay device 210. The relay device OS selection unit 211 attempts to start the relay device OS for relaying communication. In this case, a control program for the relay device OS for relaying communication is not stored on the relay device 210 and therefore the relay device 210 determines to start a relay device OS for downloading (S801).

The relay device OS selection unit 211 starts the relay device OS unit for downloading 310 (S802).

In the relay device OS unit for downloading 310, the relay device OS download unit 312 requests the relay device OS download server unit 103 of the control device 100 to download a relay device OS, via the control device communication unit 213 and the relay device communication unit 109 (S803).

The relay device OS download server unit 103 identifies, from the download request received from the relay device 210, the relay device 210 having transmitted the download request (S804).

The relay device OS download server unit 103 transmits a control program for a relay device OS (relay device OS for relaying communication) corresponding to the relay device 210 having transmitted the download request to the relay device 210. The relay device OS download unit 312 receives (downloads) the control program for the relay device OS for relaying communication, from the relay device OS download server unit 103 (S805).

The relay device OS download unit 312 requests the relay device OS installation unit 313 to install the relay device OS for relaying communication, the relay device OS being received from the relay device OS download server unit 103 (S806).

The relay device OS installation unit 313 stores (installs) the control program for the relay device OS for relaying communication (S807).

The relay device OS installation unit 313 transmits, when completing the installation, an installation completion notification to the relay device OS selection unit 211 (S808).

The relay device OS selection unit 211 starts the relay device OS unit for relaying communication 320 from the installed control program for the relay device OS (S809).

An operation example in which the relay device OS unit for relaying communication 320 in the second example embodiment is started is similar to the operation example in which the relay device OS unit for relaying communication 320 in the first example embodiment is started, and therefore detailed description will be omitted.

### [Description of Advantageous Effects]

As described above, in the second example embodiment of the present invention, relay device information and logic network configuration information are input to the control device 100, and thereby the control device 100 determines a relay device OS to be started in the relay device 210. The relay device 210 issues, when a control program for the relay device OS is not stored on the local device, a request for the control program to the control device 100 and installs the control program on the local device. Thereby, the control device 100 can execute automatic provisioning for the relay device 210. Therefore, it is unnecessary for a user to execute relay device OS setting for logic network construction by him/herself, and thereby construction of a network can be simplified.

Further, provisioning can be automatically executed by the control device 100, and therefore a role of the relay device 210 can be more rapidly modified than in a case where a user executes setting.

Further, in the second example embodiment of the present invention, the relay device 210 can select and install a relay device OS necessary for the local device. Therefore, the relay device 210 can execute various types of processings by using a smaller data capacity than in a case where all control programs for relay device OS s that may be used are previously stored.

### Third Example Embodiment

### [Description of a Configuration]

A third example embodiment of the present invention will be described in detail with reference to the drawings. Note that a technique of the third example embodiment is also applicable to any one of the first example embodiment and the second example embodiment.

A configuration example of a communication system of the third example embodiment is similar to the configuration example of the communication system of the first example embodiment exemplarily illustrated in FIG. 1, and therefore detailed description will be omitted.

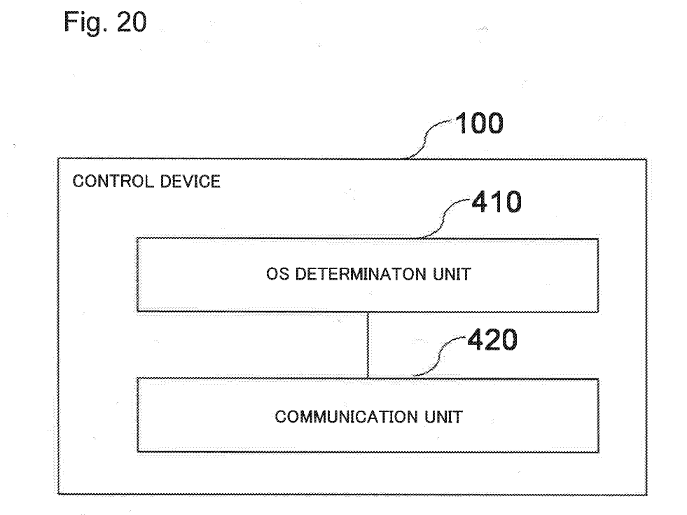

FIG. 20 is a block diagram illustrating a configuration example of a control device 100 of the third example embodiment. As illustrated in FIG. 20, the control device 100 of the third example embodiment includes an OS determination unit 410 and a communication unit 420. Note that the OS determination unit 410 and the communication unit 420 correspond to the relay device OS determination unit 108 and the relay device communication unit 109, respectively, of the relay device 100 in FIG. 2 and FIG. 12.

The OS determination unit 410 determines, based on information relating to a configuration of a network, for each of a plurality of relay devices included in the network, an OS according to a function of each of the plurality of relay devices in the network. The information relating to a configuration of a network is, for example, the logic network configuration information illustrated in FIG. 4. The OS determination unit 410 determines, based on information relating to a configuration of a network, for example, a relay device necessary for the network.

The OS determination unit 410 determines, for the determined relay device, for example, an OS to be started in the relay device according to a function of the relay device. The OS determination unit 410 determines, for example, for a relay device functioning for communication relay in a network, an OS for the communication relay. Further, the OS determination unit 410 determines, for example, for a relay device functioning as a router in a network, an OS used for the router. Further, the OS determination unit 410 determines, for example, for a relay device functioning as a load balancer in a network, an OS used for the load balancer.

The communication unit 420 notifies each of a plurality of relay devices of information relating to a determined OS. The communication unit 420 notifies each of a plurality of relay devices, for example, of a control program for a relay device OS.

Note that the communication unit 420 may inquire of each of a plurality of relay devices whether a determined OS is stored before notification of information relating to the determined OS. In this case, the communication unit 420 notifies, as a response to the inquiry, when notification of the information relating to the determined OS is requested, a relay device having made the request of the information relating to the determined OS.

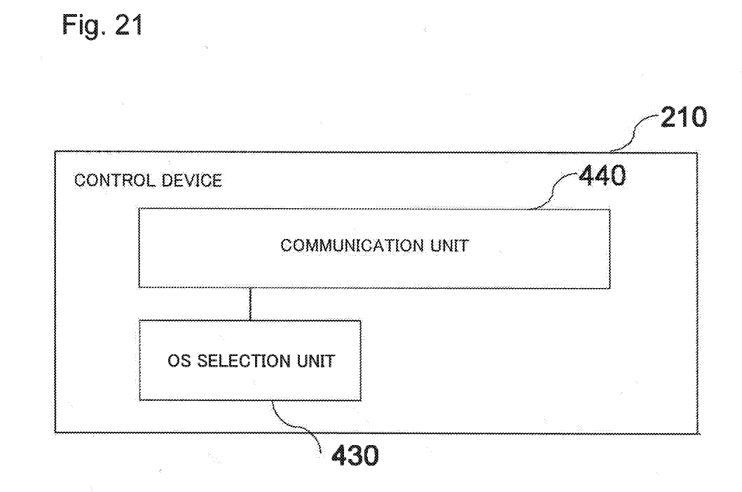

FIG. 21 is a block diagram illustrating a configuration example of the relay device 210 of the third example embodiment. As illustrated in FIG. 21, the relay device 210 of the third example embodiment includes an OS selection unit 430 and a communication unit 440. Note that the OS selection unit 430 and the communication unit 440 correspond to the relay device OS selection unit 211 and the control device communication unit 213, respectively, of the relay device 210 in FIG. 5, FIG. 13 and the like.

The OS selection unit 430 starts an OS, for example, based on information relating to the OS received from the control device 100 via the communication unit 440. The OS selection unit 430 receives, for example, a control program for a predetermined OS and starts the predetermined OS.

Note that the OS selection unit 430 may receive, before reception of information relating to an OS, an inquiry about whether information relating to the OS is stored on the relay device 210 via the communication unit 440. The OS selection unit 430 requests information relating to the determined OS when the OS selection unit 430 receives the inquiry from the control device 100 and information relating to the determined OS is not stored. On the other hand, the OS selection unit 430 starts, when information relating to the determined OS is stored, the OS, based on the stored information of the OS.

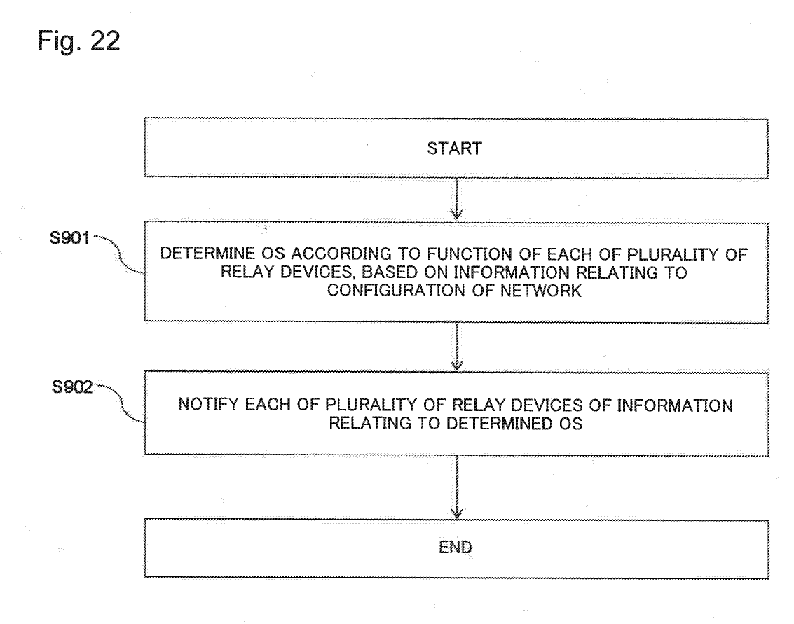

FIG. 22 is a flowchart illustrating an operation example of the control device 100 in the third example embodiment.

The OS determination unit 410 determines, based on information relating to a configuration of a network, for each of a plurality of relay devices included in the network, an OS according to a function of each of the plurality of relay devices in the network (S901). The OS determination unit 410 determines, for example, for a determined relay device, an OS to be started in the relay device according to a function of the relay device.

The communication unit 420 notifies each of a plurality of relay devices of information relating to the determined OS (S902). The communication unit 420 notifies each of a plurality of relay devices, for example, of a control program for a relay device OS.

### [Description of Advantageous Effects]

As described above, in the third example embodiment, the control device 100 determines a relay device OS to be started in the relay device 210 and notifies the relay device 210 of the determined relay device OS. Therefore, the control device 100 can execute automatic provisioning for the relay device 210. As a result, for example, it is unnecessary for a user and the like to execute relay device OS setting for network construction and the network construction can be simplified.

In addition, provisioning can be automatically executed by the control device 100, and therefore a role of the relay device 210 can be more rapidly modified than in a case where, for example, a user and the like executes setting.

In each component of the relay device 210 and the control device 100 of the example embodiments of the present invention, a central processing unit (CPU), a micro-processing unit (MPU), a memory or the like may execute software (a program) that realizes the component of FIG. 5 or FIG. 2. Further, execution may be performed by any combination of hardware and software of any computer described above including a storage device storing the program and a communication interface. FIG. 20 and FIG. 21 illustrate not a configuration of a hardware unit but a block of a logical function unit.

Further, a control device and a relay device may acquire software (a program) that realizes a function of each example embodiment described above, via various types of storage media such as a compact disc recordable (CD-R) or a network. A program acquired by a control device and a relay device and a storage medium storing the program constitute the present invention. Note that a computer, a CPU, an MPU, or the like of the software (program) control device and the relay device may be previously stored, for example, on a predetermined storage unit included in the control device and the relay device. A computer, a CPU, an MPU or the like of a control device and a relay device may read and execute a program code of acquired software (program).

Note that the present invention is not limited to each of the above-described example embodiments. The present invention can be carried out based on variations, substitutions, and adjustments of each example embodiment. Further, the present invention can be carried out using any combinations of each example embodiment. In other words, the present invention includes various variations and modifications that could be realized according to the overall disclosed contents and the technical concept of the present description. Further, the present invention is also applicable to a technical field of Software-Defined Network (SDN).

The whole or part of the example embodiments disclosed above can be described as, but not limited to, the following supplementary notes.

### [Supplementary Note 1]

A communication system comprising:

a plurality of relay devices that relay communication in a network; and

a control device that controls the plurality of relay devices, wherein

the control device determines, for each of the plurality of relay devices, an OS according to a function of each of the plurality of relay devices, based on information relating to a configuration of the network.

### [Supplementary Note 2]

The communication system according to supplementary note 1, wherein

the control device sends a message for notification of information relating to the determined OS to each of the plurality of relay devices.

### [Supplementary Note 3]

The communication system according to supplementary note 1 or 2, wherein

the control device inquires of each of the plurality of relay devices whether or not information relating to the determined OS is stored, and sends a message for notification of the information relating to the determined OS to a relay device on which the information relating to the determined OS is not stored.

### [Supplementary Note 4]

The communication system according to supplementary note 3, wherein

each of the plurality of relay devices sends, to the control device, a message for requesting the information relating to the determined OS to the control device when the inquiry is received from the control device and the information relating to the determined OS is not stored.

### [Supplementary Note 5]

The communication system according to supplementary note 3 or 4, wherein

each of the plurality of relay devices starts the determined OS when the inquiry is received from the control device and information relating to the determined OS is stored.

### [Supplementary Note 6]

The communication system according to any one of supplementary notes 2 to 4, wherein

each of the plurality of relay devices starts the determined OS in response to receiving information relating to the determined OS from the control device.

### [Supplementary Note 7]

The communication system according to any one of supplementary notes 1 to 6, wherein

information relating to each of the plurality of relay devices is stored on the control device, and the control device determines, based on the information relating to the configuration of the network and the stored information relating to the plurality of relay devices, an OS according to a function of each of the plurality of relay devices for each of the plurality of relay devices.

### [Supplementary Note 8]

A control device comprising:

an OS determination unit for determining, for each of a plurality of relay devices included in a network, an OS according to a function of each of the plurality of relay devices, based on information relating to a configuration of the network; and

a communication unit for notifying each of the plurality of relay devices of information relating to the determined OS.

### [Supplementary Note 9]

The control device according to supplementary note 8, wherein

the communication unit sends a message for notification of information relating to the determined OS to each of the plurality of relay devices.

### [Supplementary Note 10]

The control device according to supplementary note 8 or 9, wherein

the communication unit inquires of each of the plurality of relay devices whether or not information relating to the determined OS is stored, and notifies a relay device on which the information relating to the determined OS is not stored of the information relating to the determined OS.

### [Supplementary Note 11]

The control device according to any one of supplementary notes 8 to 10, further comprising

a configuration storage unit for storing information relating to each of the plurality of relay devices, wherein

the OS determination unit determines, based on the information relating to the configuration of the network and the stored information relating to the plurality of relay devices, an OS according to a function of each of the plurality of relay devices for each of the plurality of relay devices.

### [Supplementary Note 12]

A relay device that relays communication in a network, the relay device comprising:

a communication unit for receiving an inquiry about whether information relating to an OS is stored or not; and

an OS selection unit for requesting, when information relating to the determined OS is not stored, the information relating to the OS.

### [Supplementary Note 13]

The relay device according to supplementary note 12, wherein

the OS selection unit starts the OS in response to receiving information relating to the OS.

### [Supplementary Note 14]

The relay device according to supplementary note 12 or 13, wherein

the OS selection unit starts the OS when the inquiry is received and information relating to the OS is stored.

### [Supplementary Note 15]

A control method comprising:

a step of determining, for each of a plurality of relay devices included in a network, an OS according to a function of each of the plurality of relay devices, based on information relating to a configuration of the network; and

a step of sending a message to notify each of the plurality of relay devices of information relating to the determined OS.

### [Supplementary Note 16]

The control method according to supplementary note 15, further comprising

a step of sending a message to notify each of the plurality of relay devices of information relating to the determined OS.

### [Supplementary Note 17]

A storage medium storing a program that causes a computer to execute:

means for determining, for each of a plurality of relay devices included in a network, an OS according to a function of each of the plurality of relay devices, based on information relating to a configuration of the network; and

means for sending a message for notification of information relating to the determined OS to each of the plurality of relay devices.

### [Supplementary Note 18]

The storage medium storing the program according to supplementary note 17, the program further comprising

means for sending a message for notification of information relating to the determined OS to each of the plurality of relay devices.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2016-035377, filed on Feb. 26, 2016, the disclosure of which is incorporated herein in its entirety by reference.

### REFERENCE SIGNS LIST

100 Control device

101 DHCP server unit

102 Relay device OS data storage unit

103 Relay device OS download server unit

104 Relay device information storage unit

105 Relay device information input unit

106 Logic network configuration storage unit

107 Logic network configuration input unit

108 Relay device OS determination unit

109 Relay device communication unit

200 Network

210 Relay device

211 Relay device OS selection unit

212 Relay device OS storage unit

213 Control device communication unit

310 relay device OS unit for downloading

311 DHCP client unit

312 Relay device OS download unit

313 Relay device OS installation unit

320 relay device OS unit for relaying communication

321 Management function unit

322 Protocol stack unit

323 hardware control unit for relaying

410 OS determination unit

420 Communication unit

430 OS selection unit

440 Communication unit

What is claimed is:

1. A communication system comprising:
a plurality of relay devices that relay communication in a network; and
a control device that controls the plurality of relay devices, wherein
the control device determines, for each of the plurality of relay devices, an OS according to a function of each of the plurality of relay devices, based on information relating to a configuration of the network.

2. The communication system according to claim 1, wherein
the control device sends a message for notification of information relating to the determined OS to each of the plurality of relay devices.

3. The communication system according to claim 1, wherein
the control device inquires of each of the plurality of relay devices whether or not information relating to the determined OS is stored, and sends a message for notification of the information relating to the determined OS to a relay device on which the information relating to the determined OS is not stored.

4. (canceled)

5. The communication system according to claim 3, wherein
each of the plurality of relay devices sends, to the control device, a message for requesting the information relating to the determined OS to the control device, the information not being stored, when the inquiry is received from the control device.

6. The communication system according to claim 3, wherein
each of the plurality of relay devices starts the determined OS, the information being stored, when the inquiry is received from the control device.

7. The communication system according to claim 2, wherein
each of the plurality of relay devices starts the determined OS in response to receiving information relating to the determined OS from the control device.

8. The communication system according to claim 1, wherein
information relating to each of the plurality of relay devices is stored on the control device, and
the control device determines, based on the information relating to the configuration of the network and the stored information relating to the plurality of relay devices, an OS according to a function of each of the plurality of relay devices in the network for each of the plurality of relay devices.

9. (canceled)

10. A control device comprising:
an OS determination unit configured to determine, for each of a plurality of relay devices included in a network, an OS according to a function of each of the plurality of relay devices, based on information relating to a configuration of the network; and
a communication unit configured to notify each of the plurality of relay devices of information relating to the determined OS.

11. The control device according to claim 10, wherein
the communication unit is configured to send a message for notification of information relating to the determined OS to each of the plurality of relay devices.

12. The control device according to claim 10, wherein
the communication unit is configured to inquire of each of the plurality of relay devices whether or not information relating to the determined OS is stored, and notify a relay device of the information.

13. The control device according to claim 10, further comprising
a configuration storage unit configured to store information relating to each of the plurality of relay devices, wherein
the OS determination unit is configured to determine, based on the information relating to the configuration of the network and the stored information relating to the plurality of relay devices, an OS according to a function of each of the plurality of relay devices for each of the plurality of relay devices.

14. (canceled)

15. (canceled)

16. (canceled)

17. A control method comprising:
determining, for each of a plurality of relay devices included in a network, an OS according to a function of each of the plurality of relay devices, based on information relating to a configuration of the network; and
notifying each of the plurality of relay devices of information relating to the determined OS.

18. The control method according to claim 17, further comprising
notifying each of the plurality of relay devices of information relating to the determined OS.

19. (canceled)

20. (canceled)
